(19) United States
(12) Patent Application Publication
(10) Pub. No.: US 2008/0047764 A1
(43) Pub. Date: Feb. 28, 2008

(54) Temperature compensation method for capacitive sensors

(75) Inventors: Mark R. Lee, Edmonds, WA (US); Christopher M. Hammer, Millcreek, WA (US); Dennis R. Seguine, Monroe, WA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Cypress Semiconductor Corporation

(21) Appl. No.: 11/512,042

(22) Filed: Aug. 28, 2006

(51) Int. Cl. G08C 21/00

(52) U.S. Cl. 178/18.06

(57) ABSTRACT

A method and apparatus for detecting an environmental effect and a presence of a conductive object on a touch-sensing device without using a dedicated environmental effect sensor, and compensating for the environmental effect on the detection of the conductive object. The method may include detecting an environmental effect on a touch-sensing device using a touch sensor, detecting a presence of a conductive object, and compensating for the environmental effect on the detection of the conductive object. The apparatus may include a touch-sensing device having a touch sensor to detect an environmental effect and a processing device to compensate for the environmental effect.

### TECHNICAL FIELD

This invention relates to the field of user interface devices and, more particularly, to touch-sensing devices.

### BACKGROUND

Computing devices, such as notebook computers, personal data assistants (PDAs), mobile communication devices, and portable entertainment devices (such as handheld video game devices, multimedia players, and the like) have user interface devices, which are also known as human interface devices (HID), that facilitate interaction between the user and the computing device. One type of user interface device that has become more common is a touch-sensor device that operates by way of capacitance sensing. A touch-sensor device usually is in the form of a touch-sensor pad, a touch-sensor slider, or touch-sensor buttons, and includes an array of capacitive sensors. The capacitance detected by a capacitive sensor changes as a function of the proximity of a conductive object to the sensor. The conductive object can be, for example, a stylus or a user's finger.

In a touch-sensor pad, a change in capacitance detected by each sensor in the X and Y dimensions of the sensor array due to the proximity or movement of a conductive object can be measured by a variety of methods. Regardless of the method, usually an electrical signal representative of the capacitance detected by each of the capacitive sensors is processed by a processing device, which in turn develops electrical signals representative of the position of the conductive object in relation to the touch-sensor pad in the X and Y dimensions. A touch-sensor strip or a touch-sensor button operates on the same capacitance-sensing principle.

In addition to user interaction, a computing device is also subject to the effects of environmental factors such as thermal effect due to ambient temperature or moisture effects due to ambient humidity. In a system of identical capacitive sensors, for instance a computing device with a touch-sensor pad, changes in ambient temperature will affect the capacitance detected by the sensors because the self-capacitance of the touch-sensor pad changes with temperature. In general, the capacitance detected by the sensors changes linearly with changes in temperature. In some systems, the capacitance detected will have a positive temperature coefficient, and in others will have a negative coefficient. The effect on detected capacitance in all sensors due to changes in ambient temperature is known as temperature drift. With users expecting computing devices that employ capacitive sensors to be able to operate over a wide temperature range, compensation for temperature drift is required to meet performance specifications.

Typically, temperature compensation in capacitance sensing is accomplished by one of two methods: using a dedicated, stand-alone temperature sensor or compensating with software only. FIG. 1A illustrates a conventional touch-sensing device having a dedicated temperature sensor. Conventional touch-sensing device 100 includes a touch-sensor switch array and a processing device. The touch-sensor switch array may include touch-sensing switches. The processing device may include capacitive sensors that detect whether a conductive object is present on either, or none, of the touch-sensing switches. The capacitive sensors may be coupled to touch-sensing switches in a one-to-one configuration. Accordingly, the processing device scans the touch-sensing switches using the capacitive sensors, and measures the capacitance on the touch-sensing switches. A dedicated temperature sensor is coupled to the processing device. The dedicated temperature sensor is subject to the same ambient temperatures as the touch-sensing switches and, hence, allows the processing device to compensate for temperature drift by reading the temperature sensor and applying a correction factor to the capacitance it measures.

However, compensation with a dedicated, stand-alone temperature sensor not only adds significant cost to the system due to additional hardware, but also requires additional analog and digital processing resources and a priori knowledge of the temperature coefficient. Moreover, a dedicated temperature sensor requires additional board space on a printed-circuit board (PCB). With consumer demand for ever-increasing functionality in computing devices of ever-decreasing size, such a method becomes less feasible to implement.

Software-only compensation operates on the assumption that signal changes due to user interaction usually change faster than changes in ambient temperature. However, this is not always the case. For example, pressing a capacitive-sensing button, such as a Fast Forward button, for a long time as a computing device is warming up will produce a non-changing signal due to the user's capacitance and a changing signal due to self-heating in the computing device and heating due to the user's finger temperature. This poses a problem for software-only compensation that expects the signal to change faster than the environment.

With capacitive sensor relaxation oscillators (CSR), a type of capacitive sensor that will be explained in more detail below, capacitance is measured in terms of raw counts (e.g., the higher the capacitance the higher the raw counts) during periods of oscillation. CSR is one of many oscillator types in which capacitance changes at the input translate into raw count changes at the output. While a CSR oscillator is used to describe certain embodiments of the invention, the aspects of the invention described herein are applicable to any circuit type that translates capacitance chances to raw count changes. As illustrated in graph 110 of FIG. 1B, absent other factors that may affect capacitance, as heat is applied over time (shown as cycles of oscillation), the CSR raw counts 112 increase and the capacitance measured by the CSR increases over time as a result. Referring to graph 120 of FIG. 1C, under software-only compensation, a reference, or baseline 124, is tracked so the computing device knows when the user interaction is present (e.g., finger on button) by comparing the CSR raw counts 122 (representing the capacitance due to the presence of a conductive object, such as user's finger) with the baseline 124. If the CSR raw counts 122 exceed the baseline 124 by a finger threshold 126, user interaction is deemed to be present and appropriate actions are taken; otherwise, no action is taken. The baseline 124 is usually established during the warming-up phase immediately after power-on. If a user presses a button while the computing device is warming up, the software will establish a temperature higher than the ambient temperature as the baseline because, under normal conditions, the user's finger has higher temperature than ambient temperature. When the signal is not present after the computing device warms up (e.g., finger removed from button), the new baseline due to the higher temperature of the finger will be above the previous threshold for detecting the user signal. The computing device is unable to sense user interaction since the baseline is always above the finger detection threshold, and signals with value below the baseline are ignored. This is called “button lock” because no user interaction can change the system output. As a result, to a user, the computing device's touch-sensor pad will appear to lose sensitivity, turn on without a finger present or be stuck ‘on’ with no finger present.

### BRIEF DESCRIPTION OF THE DRAWINGS

The present invention is illustrated by way of example, and not by way of limitation, in the figures of the accompanying drawings.

FIG. 1A illustrates a topside view of a conventional touch-sensing device with a dedicated temperature sensor for temperature compensation.

FIG. 1B illustrates a graph of effect of rising temperature on the capacitance measured by a capacitive switch relaxation oscillator.

FIG. 1C illustrates a graph of effects of rising temperature and detection of a conductive object on the capacitance measured by a capacitive switch relaxation oscillator with software-only temperature compensation.

FIG. 2 illustrates a top-side view of one embodiment of a touch-sensing device having a touch sensor with a plurality of pins coupled to a processing device and a touch-sensing switch array.

FIG. 3A illustrates a capacitive switch.

FIG. 3B illustrates one embodiment of a sensing device coupled to a processing device.

FIG. 4A illustrates a block diagram of one embodiment of a capacitive sensor.

FIG. 4B illustrates a block diagram of one embodiment of a capacitive sensor including a relaxation oscillator and digital counter.

FIG. 5 illustrates a graph of the capacitance measured using one embodiment of the touch-sensing device of FIG. 4B.

FIG. 6A illustrates one embodiment of a method of detecting a conductive object and compensating for environmental effects.

FIG. 6B illustrates one embodiment of a method of compensating for environmental effect.

FIG. 7 illustrates a block diagram of one embodiment of an electronic system having a processing device for detecting a presence of a conductive object and compensating for the effect of an environmental factor.

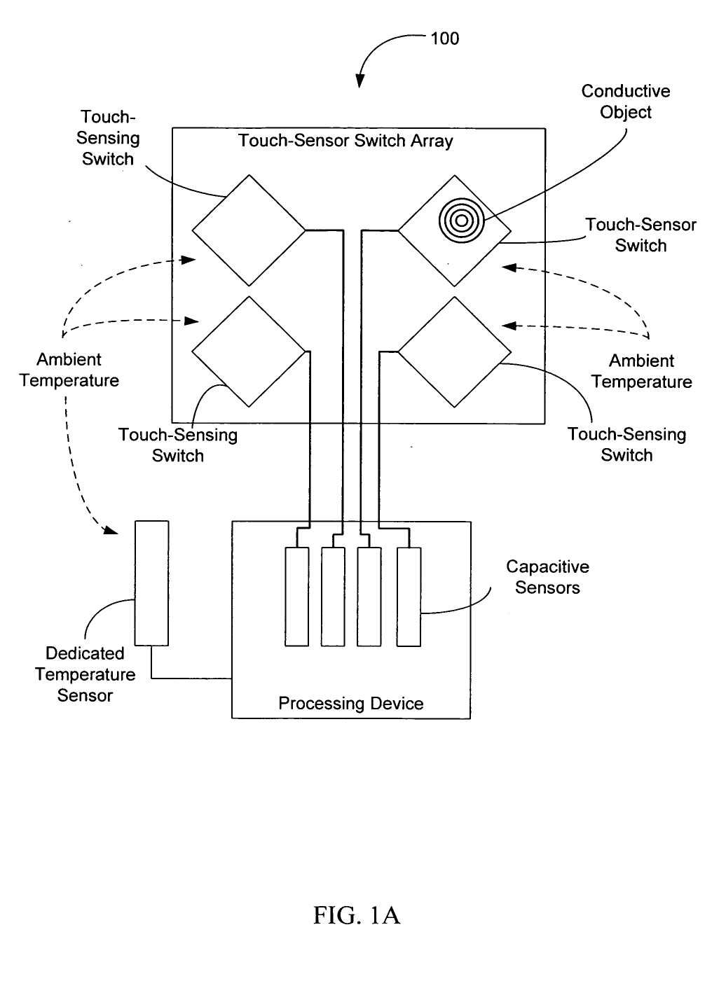

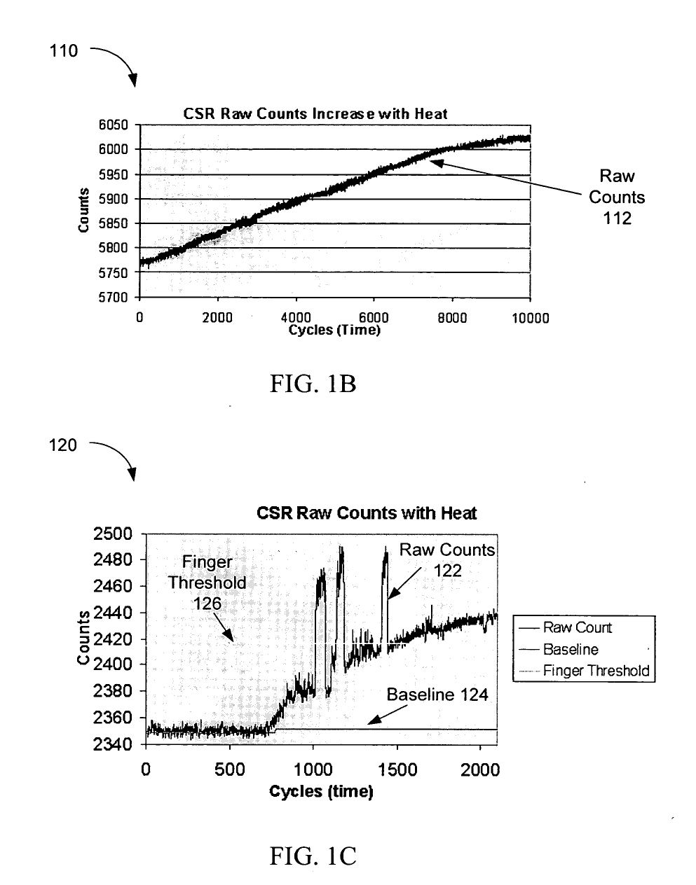

### DETAILED DESCRIPTION

Described herein is a method and apparatus for detecting an environmental effect and the presence of a conductive object on a touch-sensing device without using a dedicated environmental effect sensor, and compensating for the environmental effect on the detection of the conductive object. The following description sets forth numerous specific details such as examples of specific systems, components, methods and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram form in order to avoid unnecessarily obscuring the present invention. Thus, the specific details set forth are merely exemplary. Particular implementations may vary from these exemplary details and still be contemplated to be within the spirit and scope of the present invention.

Embodiments of a method and apparatus are described to detect an environmental effect and the presence of a conductive object on a touch-sensing device without using a dedicated environmental effect sensor, and to compensate for the environmental effect on the detection of the conductive object. In one embodiment, the method may include detecting an environmental effect on a touch-sensing device using a (reference) touch sensor that is unresponsive to the presence of a conductive object during the detection of the conductive object, detecting the presence of the conductive object with a sensor that is responsive to the presence of the conductive object, and compensating for the environmental effect on the detection of the conductive object. In one embodiment, the apparatus may include a touch-sensing device having a touch sensor to detect an environmental effect and the presence of a conductive object on the touch-sensing device, and a processing device coupled to the touch sensor to compensate for the environmental effect on the detection of the conductive object. The touch sensor may be unresponsive to the presence of the conductive object during the detection of the environmental effect. The touch sensor may include a first pin uncoupled to a touch-sensing switch and a second pin coupled to a touch-sensing switch. The processing device may be configured to read a signal corresponding to the environmental effect from the first pin and to calculate a difference value between the signal corresponding to the environmental effect from the first pin and a first baseline value related to the first pin. In effect, the processing device may be configured to adjust a first baseline value related to the first pin and a second baseline value related to the second pin if a difference value between a signal corresponding to the environmental effect from the first pin and the first baseline value exceeds a predetermined range for a predetermined amount of time.

As described herein, in a touch-sensing device having substantially similar touch sensors, all of the touch sensors will be exposed to the same environmental factors, and all of the sensors will respond to changes in the environmental factors (e.g., temperature changes) in the same way (e.g., temperature drift). One touch sensor that is exposed to the environmental effect but otherwise shielded from user interaction (e.g., a conductive object such as a stylus or the user's finger) may be responsive to the environmental effect but unresponsive to the presence of the conductive object. Compensation for the environmental effect may be achieved using the response of this particular touch sensor as a reference.

By using a touch sensor that is exposed to the environmental effect, but otherwise shielded from the user, to provide a reference for the environmental effect, the cost of a dedicated environmental effect sensor may be avoided. In addition, compensation for the environmental effect may be carried out without being impacted by the presence of a conductive object as would be in the case of a conventional software-only compensation method (e.g., the “button lock” problem caused by a user pressing a button during warm-up stage of the touch-sensing device). This is because the touch sensor shielded from the user cannot be accessed by the user and therefore any change in capacitance measured on this touch sensor will be due to the environmental effect alone. The embodiments described herein may be used for applications of touch-sensor buttons. Alternatively, the embodiments described herein may be implemented in touch-sensor pads or touch-sensor sliders.

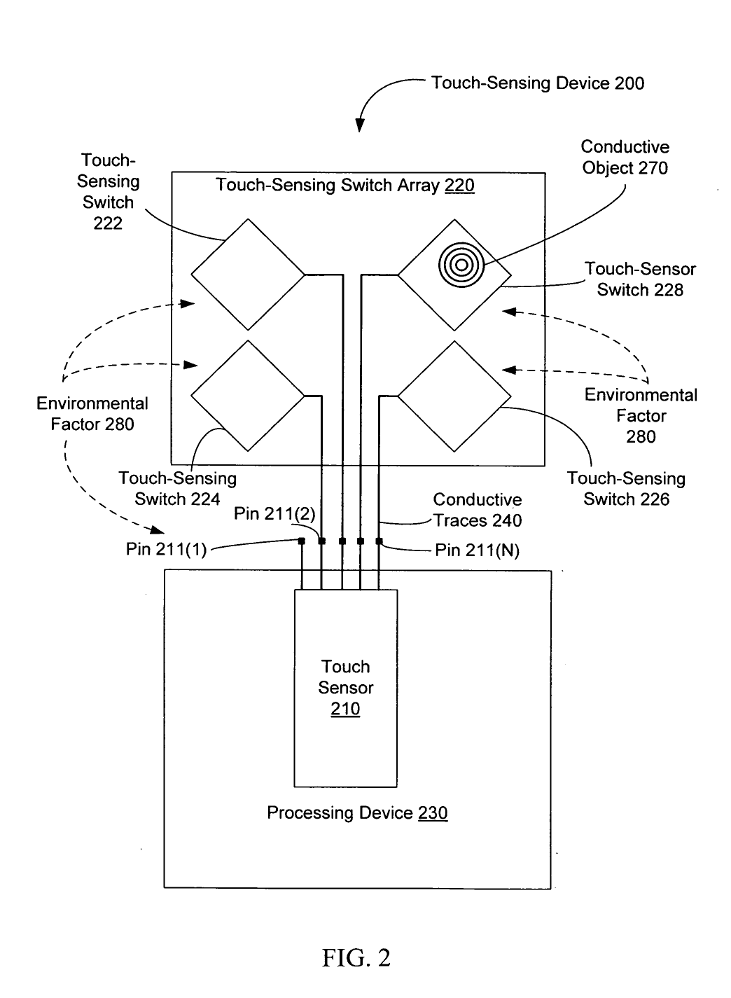

FIG. 2 illustrates a top-side view of one embodiment of a touch-sensing device for detecting a presence of a conductive object 270 on the touch-sensing switch array 220 of a touch-sensing device 200. Touch-sensing device 200 includes a touch sensor 210, processing device 230 and touch-sensing switch array 220, which includes touch-sensing switches 222, 224, 226 and 228. Touch sensor 210 includes multiple pins 221(1)-221(N), where N is a positive integer value representative of the number of pins, for coupling touch sensor 210 to touch-sensing switches 222-228 of touch-sensing switch array 220 and other components of touch-sensing device 200. In one embodiment, touch sensor 210 may be coupled to processing device 230. In an alternative embodiment, touch sensor 210 may be an integral part of processing device 230. In yet another embodiment, touch-sensing device 200 may include multiple touch sensors, each coupled to or as an integral part of processing device 230.

The touch-sensing switch array 220 may include one or multiple touch-sensing switches. In one embodiment, touch-sensing switch array 220 may include touch-sensing switches 222-228. As illustrated in FIG. 2, in one embodiment touch-sensing switches 222-228 are coupled to pins 211(2)-211(N) of touch sensor 210 via conductive traces 240 while pin 211(1) of touch sensor 210 is uncoupled to any touch-sensing switch. Each of the touch-sensing switches 222-228 may be responsive to the presence of a conductive object 270 (e.g., a stylus or a user's finger) as well as the effect of an environmental factor 280. In one embodiment, environmental factor 280 may be ambient temperature. In an alternative embodiment, environmental factor 280 may be humidity. In one embodiment, the technology employed in touch-sensing switches 222-228 to detect the presence of conductive object 228 may be capacitive sensing technology. In an alternative embodiment, the sensing technology may be resistive sensing technology or other touch-sensing technology known in the art. The methods described herein may applied to any sensor technology where adding one additional sensor adds little cost, the added sensor experiences the same environmental effects and changes in the same way as the other sensors, and/or the added sensor is shielded from user interaction or whatever non-environmental effect it is designed to sense.

It should be noted that, while the touch-sensing switch array 220 is exposed to a user for detecting user interaction in the form of a presence of a conductive object, touch sensor 210 is shielded from the user and hence is not exposed to the user interaction. It should be further noted that, although touch sensor 210 is shielded from the user, it is nevertheless subject to the effect of environmental factor 280. As illustrated in FIG. 2, environmental factor 280 may have an effect on touch-sensing device 200 and its components, such as touch-sensing switches 222-228, conductive traces 240, pins 211(1)-211(N), and touch sensor 210 (e.g., effects on the dielectric constant of the printed circuit board material and/or resources shared by the sensors, such as current sources and/or voltage references). The temperature coefficient of capacitance of touch-sensing device 200, touch-sensing switches 222-228, conductive traces 240, and pins 211(1)-211(N) and touch sensor 210 may be positive or negative depending on the materials used in the fabrication of those elements.

As illustrated in FIG. 2, in one embodiment, pin 211(1) of touch sensor 210 may be uncoupled to any touch-sensing switch of the touch-sensing switch array 220. Because pin 211(1) is subject to the effect of environmental factor 280, in one embodiment the capacitance measured on pin 211(1) may be used as a reference to compensate for the effect of environmental factor 280. In one embodiment, processing device 230 is configured to read a signal from uncoupled pin 211(1), where the signal is representative of capacitance measured on pin 211(1) corresponding to the effect of environmental factor 280. In an alternative embodiment, processing device 230 is configured to calculate a difference value between the signal corresponding to the effect of environmental factor 280 from pin 211(1) and a baseline value of pin 211(1), where the baseline value may be representative of a previously measured environmental effect. In yet another embodiment, processing device 230 is configured to adjust the baseline value of pin 211(1) and the baseline value of any of the pins 211(2)-211(N) that is coupled to a touch-sensing switch, if the difference between the signal corresponding to the effect of environmental factor 280 from pin 211(1) and the baseline value of pin 211(1) exceeds a specified range for a specified time.

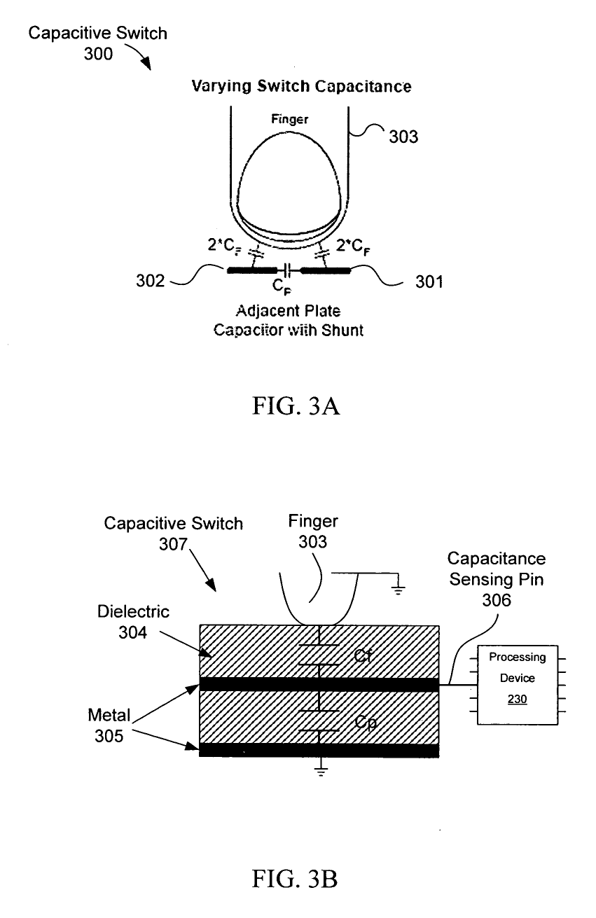

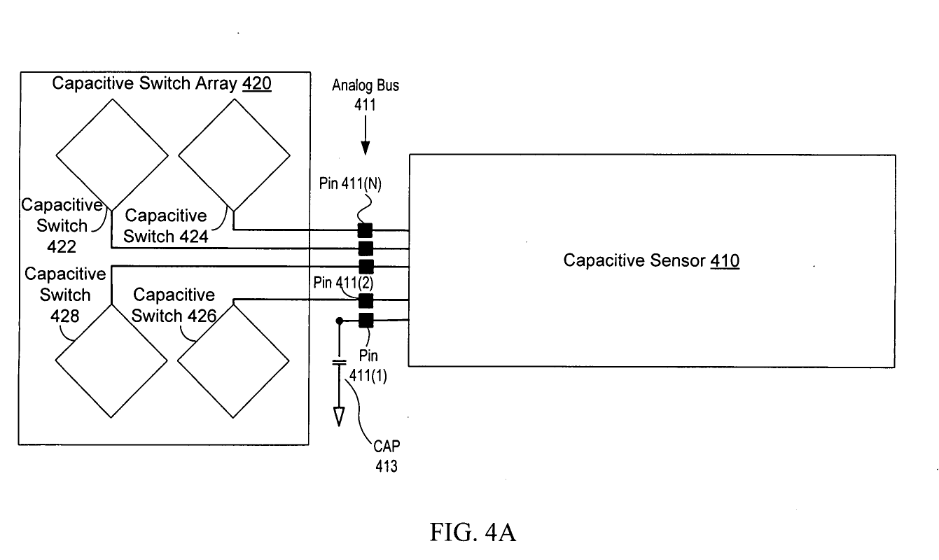

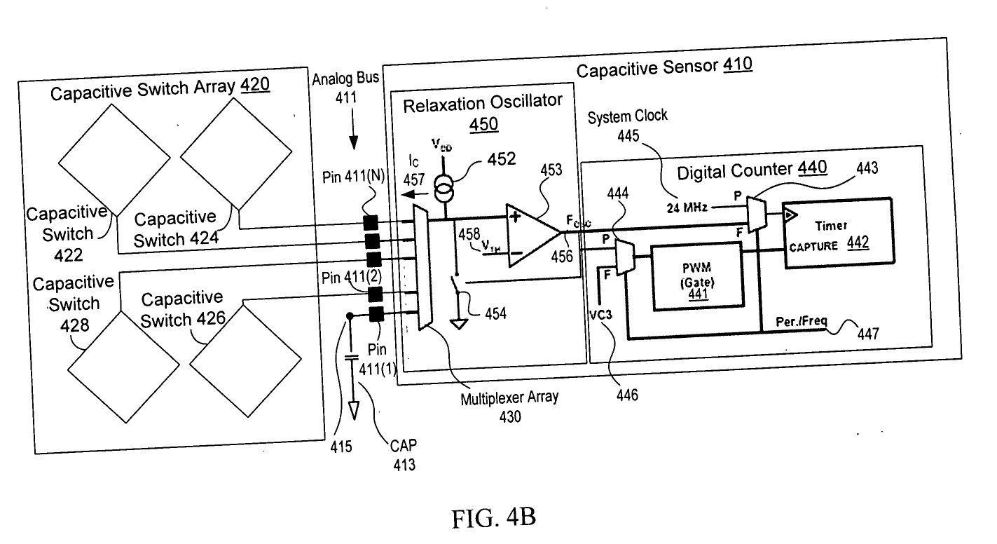

FIG. 3A illustrates how a conductive object may affect the capacitance of a capacitive touch-sensing switch. In its basic form, a capacitive switch 300 is a pair of adjacent plates (electrodes) 301 and 302. There is a small edge-to-edge capacitance Cₚ, but the intent of switch layout is to minimize the base capacitance Cₚ between these plates. When a conductive object 303 (e.g., a finger) is placed in proximity to the two plates 301 and 302, there is a capacitance 2*C_{F} between one electrode 301 and the conductive object 303 and a similar capacitance 2*C_{F} between the conductive object 303 and the other electrode 302. The capacitance 2*C_{F} between electrode 301 and the conductive object 303 and the capacitance 2*C_{F} between electrode 302 and the conductive object 303 add in series to yield a capacitance C_{F}. That capacitance adds in parallel to the base capacitance Cₚ between the plates 301 and 302, resulting in a change of capacitance C_{F} over the base capacitance. Capacitive switch 300 may be used in a capacitive switch array. The capacitive switch array is a set of capacitors where one electrode of each capacitor is grounded. Thus, the active capacitor (as represented in FIGS. 4A and 4B as capacitive switches 422-428) has only one accessible side. The presence of the conductive object 303 increases the capacitance (Cₚ+C_{F}) of the capacitive switch 300 to ground. Determining switch activation is then a matter of measuring the change in the capacitance (C_{F}) or capacitance variation. Capacitive switch 300 is also known as a grounded variable capacitor. In one exemplary embodiment, C_{F} may range from approximately 10-30 picofarads (pF). Alternatively, other ranges may be used.

The conductive object in this case is a finger, alternatively, this technique may be applied to any conductive object, for example, a conductive door switch, position sensor, or conductive pen in a stylus tracking system (e.g., stylus).

FIG. 3B illustrates one embodiment of a capacitive switch 307 coupled to a processing device 230. Capacitive switch 307 illustrates the capacitance as seen by the processing device 230 on the capacitance sensing pin 306. As previously described, when a conductive object 303 (e.g., a finger) is placed in proximity to one of the metal plates 305, there is an effective capacitance, C_{F}, between the metal plate and the conductive object 303 with respect to ground. Also, there is a capacitance, Cₚ, between the two metal plates. Accordingly, the processing device 230 can measure the change in capacitance, capacitance variation C_{F}, when the conductive object is in proximity to the metal plate 305. Above and below the metal plate that is closest to the conductive object 303 is dielectric material 304. The dielectric material 304 above the metal plate 305 can be the overlay, as described in more detail below. The overlay may be non-conductive material used to protect the circuitry to environmental elements and to insulate the conductive object (e.g., the user's finger) from the circuitry. Capacitive switch 307 may be a touch-sensing switch of a touch-sensor pad, a touch-sensor slider or a touch-sensor button.

FIG. 4A illustrates a block diagram of one embodiment of a capacitive sensor. In one embodiment, capacitive sensor 410 may be coupled to a capacitive switch array 420 via analog bus 411. Analog bus 411 may include multiple pins 411(1)-411(N), where N is a positive integer value representative of the number of pins. The capacitive switch array 420 may include capacitive switches 422, 424, 426 and 428 that are responsive to the presence of a conductive object as well as the effect of an environmental factor. In one embodiment, capacitive switches 422-428 may be diamond-shaped. In alternative embodiments, capacitive switches 422-428 may be round, triangular, rectangular, hexagonal, or in other polygonal shape. In one embodiment, capacitive sensor 410 is coupled to capacitive switches 422-428 via pins 411(2)-411(N); and capacitive sensor 410 and pins 411(1)-411(N) may be shielded from the user. In one embodiment, pin 411(1) may be uncoupled. In an alternative embodiment, pin 411(1) may be coupled to a conductive element, such as a conductive trace or the like, and the conductive element is shielded from the user so it does not respond to the presence of a conductive object that represents user interaction. In yet another embodiment, pin 411(1) may be used for other input/output functions, or as a standard capacitive sensor input, so long as it is shielded from the user and does not respond to the presence of a conductive object that represents user interaction. Whether pin 411(1) is uncoupled, coupled to a conductive element or used for other input/output functions, pin 411(1) will have parasitic capacitance as represented in FIG. 4A as capacitor 413. Since capacitor 413 is not exposed to the user and does not respond to the presence of a conductive object, the capacitance of capacitor 413 measured on pin 411(1) may be used as the reference, or baseline, for other pins that are coupled to capacitive switch array 420 for purposes such as compensating for the effect of an environmental factor (e.g., ambient temperature).

FIG. 4B illustrates a block diagram of one embodiment of a capacitive sensor including a relaxation oscillator and digital counter. The relaxation oscillator 450 is formed by the capacitance to be measured on any of pins 411(1)-411(N), a charging current source 452, a comparator 453 and a reset switch 454. The relaxation oscillator is coupled to drive a charging current (I_{C}) 457 in a single direction onto a capacitor coupled to any of pins 411(1)-411(N). As the charging current adds charge to the capacitor, say, capacitor 413 for example, the voltage across the capacitor increases with time as a function of I_{C} 457 and its capacitance C. Equation (1a) describes the relation between current, capacitance, voltage and time for a charging capacitor. The voltage on the capacitor may be found by rearranging and integrating equation (1a), as shown in equation (1b). Alternatively, the time required for the capacitor to reach a voltage V is given by equation (1c).

$$\begin{matrix}CdV = {I}_{C} dt & ( 1 a ) \\ V ( t ) = \frac{1}{C} {\int }_{0}^{t} {I}_{C} d t & ( 1 b ) \\ t ( V ) = \frac{C}{{I}_{C}} {\int }_{0}^{V} d v & ( 1 c )\end{matrix}$$

The relaxation oscillator begins by charging the capacitor 413 from a ground potential or zero voltage and continues to add charge to the capacitor 413 at a fixed charging current I_{C} 457 until the voltage across the capacitor 413 at node 415 reaches a reference voltage or threshold voltage, V_{TH} 458. The time required for the capacitor voltage to reach V_{TH} is T_{RO}, which is the period of oscillation of the relaxation oscillator. At V_{TH} 458, the relaxation oscillator allows the accumulated charge at node 415 to discharge (e.g., the capacitor 413 to “relax” back to the ground potential) and then the process repeats itself. In particular, the output of comparator 453 asserts a clock signal F_{OUT} 456 (e.g., F_{OUT} 456 goes high), which enables the reset switch 454. This resets the voltage on the capacitor at node 415 to ground and the charge cycle starts again. The relaxation oscillator outputs a relaxation oscillator clock signal (F_{OUT} 456) having a frequency (f_{RO}=1/T_{RO}) dependent upon capacitance C of the capacitor 413 and charging current I_{C} 457. It should be noted that the operation of relaxation oscillator 450 described herein is true for each of the capacitors coupled to pins 411(1)-411(N) and not just capacitor 413.

The trip time of the comparator 453 and reset switch 454 adds a fixed delay. The output of the comparator 453 is synchronized with a reference system clock to guarantee that the comparator reset time is long enough to completely reset the charging voltage on capacitor 415. This sets a practical upper limit to the operating frequency. For example, if capacitance C of the capacitor 413 changes, then f_{RO} will change proportionally according to Equation (1). By comparing f_{RO} of F_{OUT} 456 against the frequency (f_{REF}) of a known reference system clock signal (REF CLK), the change in capacitance ΔC can be measured. Accordingly, equations (2) and (3) below describe that a change in frequency between F_{OUT} 456 and REF CLK is proportional to a change in capacitance of the capacitor 413.

ΔC∝1/Δf, where (2)

Δf=f_{RO}−f_{REF}. (3)

In one embodiment, a frequency comparator may be coupled to receive relaxation oscillator clock signal (F_{OUT} 456) and REF CLK, compare their frequencies f_{RO} and f_{REF}, respectively, and output a signal indicative of the difference Δf between these frequencies. By monitoring Δf one can determine whether the capacitance of the capacitor 413 has changed.

In one exemplary embodiment, the relaxation oscillator 450 may be built using a programmable timer (e.g., a 555 timer) to implement the comparator 453 and reset switch 454. Alternatively, the relaxation oscillator 450 may be built using other circuitry. Relaxation oscillators are known by those of ordinary skill in the art, including relaxation oscillators that operate in the frequency measurement mode described above as well as a period measurement mode described briefly below. Accordingly, additional details regarding their operation have not been included so as to not obscure the present embodiments.

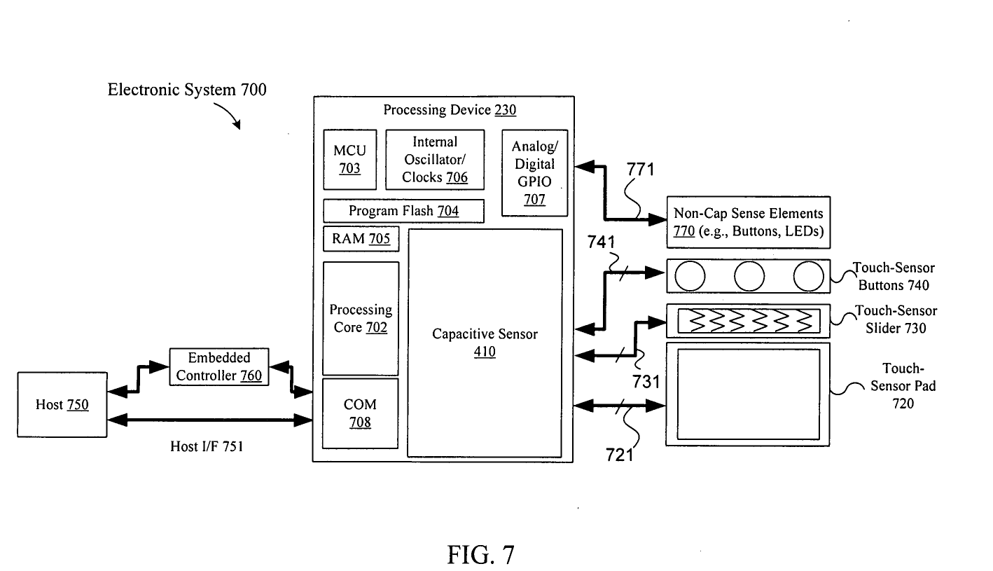

Capacitive sensor 410 of FIG. 4B is coupled to a capacitive switch array 420 (also known as a switch array), and includes relaxation oscillator 450, and a digital counter 440. In one embodiment, capacitive switch array 420 may include a plurality of capacitive switches, herein represented by capacitive switches 422, 424, 426 and 428. Each capacitive switch can be represented as a capacitor, as previously described with respect to FIG. 3B. The capacitive switch array 420 is coupled to relaxation oscillator 450 via an analog bus 411 having a plurality of pins 411(1)-411(N). In one embodiment, the switch array 420 may be a single-dimension capacitive switch array including the capacitive switches 422-428. The switch array 420 provides output data to the analog bus 411 of the processing device 230 (e.g., via bus 731 as illustrated in FIG. 7). Alternatively, the switch array 420 may be a multi-dimension capacitive switch array including the capacitive switches 422-428. The multi-dimension capacitive switch array 420 provides output data to the analog bus 411 of the processing device 230 (e.g., via bus 721 as illustrated in FIG. 7).

Relaxation oscillator 450 of FIG. 4B also includes a selection circuit 430. The selection circuit 430 is coupled to the plurality of pins 411(1)-411(N), the reset switch 454, the current source 452 and the comparator 453. Selection circuit 430 may be used to allow the relaxation oscillator 450 to measure capacitance on multiple capacitive switches (e.g., rows or columns) coupled to the pins. The selection circuit 430 may be configured to sequentially select a capacitive switch of the plurality of capacitive switches to provide the charge current I_{C} 457 and to measure the capacitance of each capacitive switch. In one exemplary embodiment, as illustrated in FIG. 4B, the selection circuit 430 is a multiplexer array of the relaxation oscillator 450. Alternatively, selection circuit may be other circuitry outside the relaxation oscillator 450, or even outside the capacitive sensor 410 to select the capacitive switch to be measured. Capacitive sensor 410 may include one relaxation oscillator and digital counter for the plurality of capacitive switches of the switch array. Alternatively, capacitive sensor 410 may include multiple relaxation oscillators and digital counters to measure capacitance of the plurality of capacitive switches of the switch array. The multiplexer array may also be used to ground the capacitive switches that are not being measured. This may be done in conjunction with a dedicated pin in the GPI0 port 707 as illustrated in FIG. 7.

Digital counter 440 is coupled to the output of the relaxation oscillator 450. Digital counter 440 receives the relaxation oscillator output signal 456 (F_{OUT}). Digital counter 440 is configured to count at least one of a frequency or a period of the relaxation oscillator output received from the relaxation oscillator.

As previously described with respect to the relaxation oscillator 450, when a finger or conductive object is placed on the capacitive switch, the capacitance increases from C_{P} to C_{P}+C_{F} so the relaxation oscillator output signal 456 (F_{OUT}) decreases. The relaxation oscillator output signal 456 (F_{OUT}) is fed to the digital counter 440 for measurement. There are two methods for counting the relaxation oscillator output signal 456, frequency measurement and period measurement. In one embodiment, the digital counter 440 may include two multiplexers 443 and 444. Multiplexers 443 and 444 are configured to select the inputs for the PWM 441 and the timer 442 for the two measurement methods, frequency measurement and period measurement, in response to a period/frequency select signal 447. Alternatively, other selection circuits may be used to select the inputs for the PWM 441 and the timer 442. In an alternative embodiment, multiplexers 443 and 444 are not included in the digital counter, for example, the digital counter 440 may be configured in one, or the other, measurement configuration.

In the frequency measurement method, the relaxation oscillator output signal 456 is counted for a fixed period of time (gate time). The timer 442 is read to obtain the number of counts during the gate time. This method works well at low frequencies where the oscillator reset time is small compared to the oscillator period. A pulse width modulator (PWM) 441 is clocked for a fixed period by a derivative of the system clock, VC3 446 (which is a divider from system clock 445, e.g., 24 MHz). Pulse width modulation is a modulation technique that generates variable-length pulses to represent the amplitude of an analog input signal; in this case VC3 446. The output of PWM 441 enables timer 442. The relaxation oscillator output signal 456 clocks the timer 442. The timer 442 is reset at the start of the sequence, and the count value is read out at the end of the gate period.

In the period measurement method, the relaxation oscillator output signal 456 gates a timer 442, which is clocked by the system clock 445 (e.g., 24 MHz). In order to improve sensitivity and resolution, multiple periods of the oscillator are counted with the PWM 441. The output of PWM 441 is used to gate the timer 442. In this method, the relaxation oscillator output signal 456 drives the clock input of PWM 441. As previously described, pulse width modulation is a modulation technique that generates variable-length pulses to represent the amplitude of an analog input signal; in this case the relaxation oscillator output signal 456. The output of the PWM 441 enables timer 442 (e.g., 16-bit), which is clocked at the system clock frequency 445 (e.g., 24 MHz). When the output of PWM 441 is asserted (e.g., goes high), the count starts by releasing the capture control. When the terminal count of the PWM 441 is reached, the capture signal is asserted (e.g., goes high), stopping the count and setting the PWM's interrupt. The timer value is read in this interrupt. The relaxation oscillator 450 is coupled to the next switch (e.g., capacitor coupled to pin 411(2)) to be measured and the count sequence is started again.

The two counting methods may have equivalent performance in sensitivity and signal-to-noise ratio (SNR). The period measurement method may have a slightly faster data acquisition rate, but this rate is dependent on software loads and the values of the switch capacitances. The frequency measurement method has a fixed-switch data acquisition rate.

The length of the timer 442 and the detection time required for the switch are determined by sensitivity requirements. Small changes in the capacitance on capacitor 413, for example, result in small changes in frequency. In order to find these small changes, it may be necessary to count for a considerable time.

At startup (or boot) the switches (e.g., capacitors coupled to pins 411(1)-411(N)) are scanned and the count values for each switch with no actuation are stored as a baseline array of C_{P} values for the switches. The presence of a finger on the switch is determined by the difference in counts between a stored value for no switch actuation and the acquired value with switch actuation, referred to here as Δn. The sensitivity of a single switch is approximately:

$$\frac{Δ n}{n} = \frac{{C}_{F}}{{C}_{P}} \qquad ( 4 )$$

The value of Δn should be large enough for reasonable resolution and clear indication of switch actuation. This drives switch construction decisions.

C_{F} should be as large a fraction of C_{P} as possible. In one exemplary embodiment, the ratio of C_{F}/C_{P} ranges between approximately 0.01 to approximately 2.0. Alternatively, other ratios may be used for C_{F}/C_{P}. Since C_{F} is determined by finger area and distance from the finger to the switch's conductive traces (through the over-lying insulator), the baseline capacitance C_{P} should be minimized. The baseline capacitance C_{P} includes the capacitance of the switch pad plus any parasitics, including routing and chip pin capacitance.

In switch array applications, variations in sensitivity among switches should be minimized. If there are large differences in Δn from one switch to another, one switch may actuate at 1.0 cm, while another may not actuate until direct contact. This presents a non-ideal user interface device. There are numerous methods for balancing the sensitivity. These may include precisely matching on-board capacitance with PC trace length modification, adding balance capacitors on each switch's PC board trace, and/or adapting a calibration factor to each switch to be applied each time the switch is tested.

It should be noted that the count window should be long enough for Δn to be a “significant number.” In one embodiment, the “significant number” can be as little as 10, or alternatively, as much as several hundred. In one exemplary embodiment, where C_{F} is 1.0% of C_{P} (a typical “weak” switch), and where the switch threshold is set at a count value of 20, n is found to be:

$$n = Δ n \cdot \frac{{C}_{F}}{{C}_{P}} = 2000 \qquad ( 5 )$$

Adding some margin to yield 2500 counts, and running the frequency measurement method at 1.0 MHz, the detection time for the switch is 2.5 milliseconds. In the frequency measurement method, the frequency difference between a switch with and without actuation (i.e., C_{P}+C_{F} vs. C_{P}) is approximately:

$$Δ n = \frac{{t}_{count} \cdot {i}_{c}}{{V}_{TH}} \frac{{C}_{F}}{{C}_{P}^{2}} \qquad ( 6 )$$

This shows that the sensitivity variation between one channel and another is a function of the square of the difference in the two channels' static capacitances. This sensitivity difference can be compensated using routines in high-level Application Programming Interfaces (APIs).

In the period measurement method, the count difference between a switch with and without actuation (i.e., C_{P}+C_{F} vs. C_{P}) is approximately:

$$Δ n = {N}_{Periods} \cdot \frac{{C}_{F} \cdot {V}_{TH}}{{i}_{C}} \cdot {f}_{SysClk} \qquad ( 7 )$$

The charge currents are typically lower and the period is longer to increase sensitivity, or the number of periods for which f_{SysClk} is counted can be increased. In either method, by matching the static (parasitic) capacitances Cₚ of the individual switches, the repeatability of detection increases, making all switches work approximately at the same difference. Compensation for this variation can be done in software at runtime. The compensation algorithms for both the frequency method and period method may be included in the high-level APIs.

Some implementations of this circuit use a current source programmed by a fixed-resistor value. If the range of capacitance to be measured changes, external components (e.g., resistors) should be adjusted.

In one embodiment, using the multiplexer array 430, multiple capacitive switches may be sequentially scanned to provide current to and measure the capacitance from the capacitors (e.g., capacitive switches), as previously described. In other words, while one capacitive switch is being measured, the remaining capacitive switches are grounded using the GPIO port 707 as illustrated in FIG. 7. This drive and multiplex arrangement bypasses the existing GPIO to connect the selected pin to an internal analog multiplexer (mux) bus. The capacitor charging current (e.g., current source 452) and reset switch 454 are connected to the analog mux bus. This may limit the pin-count requirement to simply the number of switches (e.g., capacitors coupled to pins 411(1)-411(N)) to be addressed. In one exemplary embodiment, no external resistors or capacitors are required inside or outside the processing device 230 to enable operation.

The capacitor charging current for the relaxation oscillator 450 may be generated in a register programmable current output DAC (also known as IDAC). Accordingly, the current source 452 is a current DAC or IDAC. The IDAC output current may be set by an 8-bit value provided by the processing device 230, such as from the processing core of processing device 230. The 8-bit value may be stored in a register or in memory.

Estimating and measuring PCB capacitances may be difficult. The oscillator-reset time may add to the oscillator period (especially at higher frequencies); and there may be some variation to the magnitude of the IDAC output current with operating frequency. Accordingly, the optimum oscillation frequency and operating current for a particular switch array may be determined to some degree by experimentation.

In many capacitive switch designs the two “plates” (e.g., 301 and 302) of the sensing capacitor are actually adjacent sensor elements that are electrically isolated (e.g., PCB pads or traces), as indicated in FIG. 3A. Typically, one of these plates is grounded. Layouts for touch-sensor slider (e.g., linear slide switches) and touch-sensor pad applications have switches that are immediately adjacent. In this case, all of the switches that are not active are grounded through the GPIO 707 of the processing device 230 dedicated to that pin, as illustrated in FIG. 7. The actual capacitance between adjacent plates is small (C_{P}), but the capacitance of the active plate (and its PCB trace back to the processing device 230) to ground, when detecting the presence of the conductive object 303, may be considerably higher (C_{P}+C_{F}). The capacitance of two parallel plates is given by the following equation:

$$C = {ɛ}_{0} \cdot {ɛ}_{R} \cdot \frac{A}{d} = {ɛ}_{R} \cdot 8.85 \cdot \frac{A}{d} pF \text{/} m \qquad ( 8 )$$

The dimensions of equation (8) are in meters. This is an approximation of the capacitance. The reality is that there are fringing effects that substantially increase the switch-to-ground (and PCB trace-to-ground) capacitance.

Switch sensitivity (i.e., actuation distance) may be increased by one or more of the following: 1) increasing board thickness to increase the distance between the active switch and any parasitics; 2) minimizing PC trace routing underneath switches; 3) utilizing a gridded ground with 50% or less fill if use of a ground plane is absolutely necessary; 4) increasing the spacing between switch pads and any adjacent ground plane; 5) increasing pad area; 6) decreasing thickness of any insulating overlay; or 7) verifying that there is no air-gap between the PC pad surface and the touching finger.

There is some variation of switch sensitivity as a result of environmental factors such as ambient temperature and humidity. A baseline update routine, which compensates for this variation, may be provided in the firmware or high-level APIs.

Sliding switches are used for control requiring gradual adjustments. Examples include a lighting control (dimmer), volume control, graphic equalizer, and speed control. These switches are mechanically adjacent to one another. Actuation of one switch results in partial actuation of physically adjacent switches. The actual position in the sliding switch is found by computing the centroid location of the set of switches activated.

In applications for touch-sensor sliders (e.g., sliding switches) and touch-sensor pads it is often necessary to determine finger (or other capacitive object) position to more resolution than the native pitch of the individual switches. The contact area of a finger on a sliding switch or a touch-pad is often larger than any single switch. In one embodiment, in order to calculate the interpolated position using a centroid, the array is first scanned to verify that a given switch location is valid. The requirement is for some number of adjacent switch signals to be above a noise threshold. When the strongest signal is found, this signal and those immediately adjacent are used to compute a centroid:

$$Centroid = \frac{{n}_{i - 1} \cdot ( i - 1 ) + {n}_{i} i + {n}_{i + 1} \cdot ( i + 1 )}{{n}_{i - 1} + {n}_{i} i + {n}_{i + 1}} \qquad ( 9 )$$

The calculated value will almost certainly be fractional. In order to report the centroid to a specific resolution, for example a range of 0 to 100 for 12 switches, the centroid value may be multiplied by a calculated scalar. It may be more efficient to combine the interpolation and scaling operations into a single calculation and report this result directly in the desired scale. This may be handled in the high-level APIs. Alternatively, other methods may be used to interpolate the position of the conductive object.

A physical touchpad assembly is a multi-layered module to detect a conductive object. In one embodiment, the multi-layer stack-up of a touchpad assembly includes a PCB, an adhesive layer and an overlay. The PCB includes the processing device 230 and other components, such as the connector to the host 750 as illustrated in FIG. 7, necessary for operations for sensing the capacitance. These components are on the non-sensing side of the PCB. The PCB also includes the sensor array on the opposite side, the sensing side of the PCB. Alternatively, other multi-layer stack-ups may be used in the touchpad assembly.

The PCB may be made of standard materials, such as FR4 or Kapton™ (e.g., flexible PCB). In either case, the processing device 230 may be attached (e.g., soldered) directly to the sensing PCB (e.g., attached to the non-sensing side of the PCB). The PCB thickness varies depending on multiple variables, including height restrictions and sensitivity requirements. In one embodiment, the PCB thickness is at least approximately 0.3 millimeters (mm). Alternatively, the PCB may have other thicknesses. It should be noted that thicker PCBs may yield better results. The PCB length and width is dependent on individual design requirements for the device on which the sensing device is mounted, such as a notebook or mobile handset.

The adhesive layer is directly on top of the PCB sensing array and is used to affix the overlay to the overall touchpad assembly. Typical material used for connecting the overlay to the PCB is non-conductive adhesive such as 3M 467 or 468. In one exemplary embodiment, the adhesive thickness is approximately 0.05 mm. Alternatively, other thicknesses may be used.

The overlay may be non-conductive material used to protect the PCB circuitry to environmental elements and to insulate the user's finger (e.g., conductive object) from the circuitry. Overlay can be ABS plastic, polycarbonate, glass or Mylar™. Alternatively, other materials known by those of ordinary skill in the art may be used. In one exemplary embodiment, the overlay has a thickness of approximately 1.0 mm. In another exemplary embodiment, the overlay thickness has a thickness of approximately 2.0 mm. Alternatively, other thicknesses may be used.

The switch array may be a grid-like pattern of sensor elements (e.g., capacitive switches) used in conjunction with the touch sensor 210 and processing device 230 to detect a presence of a conductive object, such as finger, to a resolution greater than that which is native. A touch-sensor pad layout pattern may be used which maximizes the area covered by conductive material, such as copper, in relation to spaces necessary to define the rows and columns of the sensor array.

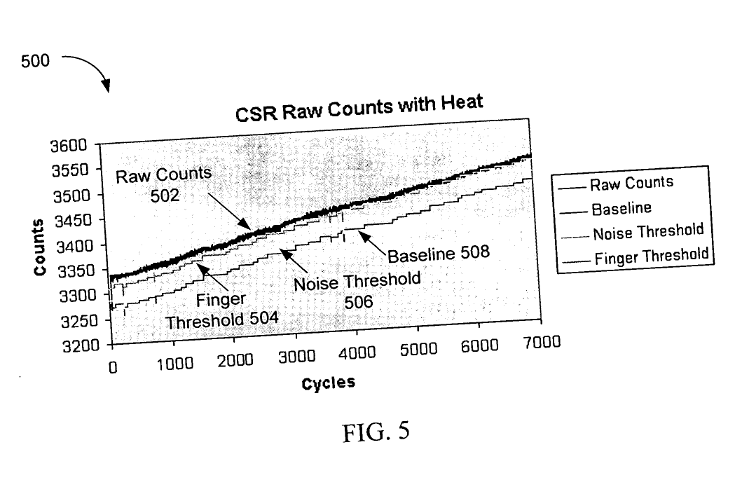

FIG. 5 illustrates a graph 500 of the capacitance measured using one embodiment of the touch-sensing device of FIG. 4B. In one embodiment, with pin 211(1) shielded from user interaction and not coupled to a touch-sensing switch, the capacitance measured on pin 211(1) is responsive to the effect of an environmental factor but unresponsive to the presence of a conductive object. Accordingly, the capacitance measured on pin 211(1) may be used as the reference for compensation for the effect of the environmental factor on capacitance measured on pins that are coupled to touch-sensing switches. In one embodiment, as the ambient temperature increases, the measured capacitance on a touch-sensing switch increases due to the temperature coefficient of capacitance of the touch-sensing switch. As a result, the corresponding CSR raw counts 502 increases as time goes on (i.e., as shown in FIG. 5 as cycles of a relaxation oscillator). Because of temperature compensation using the capacitance measured on pin 211(1), baseline 508 increases as temperature increases to account for the temperature increase. In one embodiment, finger threshold 504 and noise threshold 506 may be each set to be higher than baseline 508 by a specified range, with finger threshold 504 higher than noise threshold 506. As illustrated in FIG. 5, both finger threshold 504 and noise threshold 506 increase as baseline 508 increases, since finger threshold 504 and noise threshold are set to be higher than baseline 508 by a certain amount of counts.

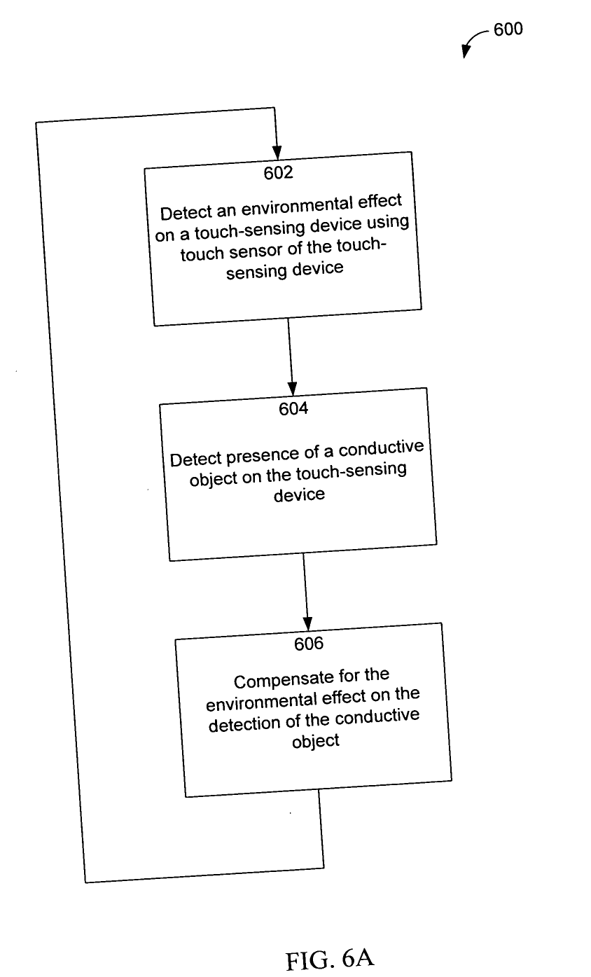

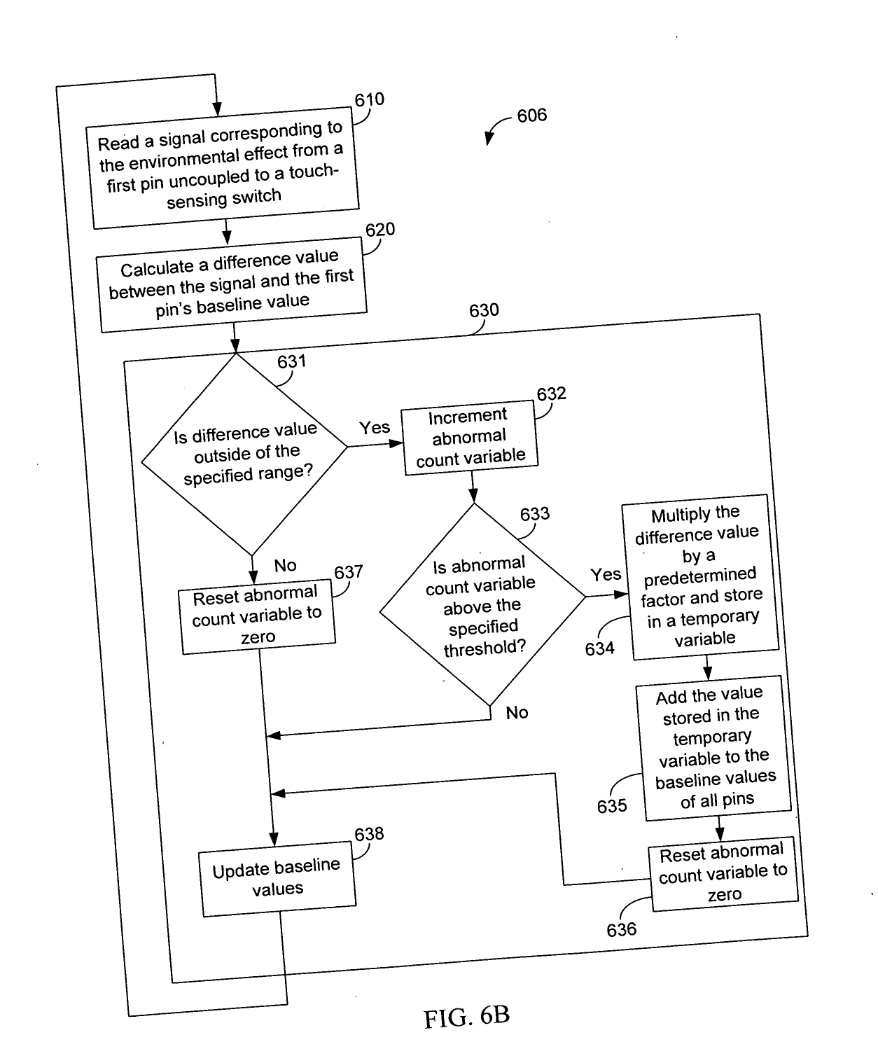

FIG. 6A illustrates one embodiment of a method 600 of detecting a conductive object and compensating for an environmental effect. In this embodiment, an environmental effect on a touch-sensing device is detected by a touch sensor of the touch-sensing device (step 602). The presence of a conductive object is detected by the touch sensor of the touch-sensing device (step 604). The environmental effect is compensated for (step 606). In one embodiment, unlike conventional software-only compensation method where compensation is done when no conductive object is expected to be present, compensation for environmental effect in step 606 may be performed even while the touch sensor is detecting the presence of the conductive object. In particular, in this embodiment, environmental effect on the touch-sensing device can be correctly compensated because the baseline can be accurately updated without encountering the “button lock” problem associated with a conductive object being present while compensation is carried out. In other words, in step 606, compensation for the environmental effect by adjusting the baseline is not affected by the presence of a conductive object.

FIG. 6B illustrates one exemplary embodiment of a method of compensating for environmental effect. In this embodiment, a signal corresponding to the environmental effect is read from a pin uncoupled to a touch-sensing switch (step 610). In one embodiment, the pin uncoupled to a touch-sensing switch may be uncoupled to anything. In an alternative embodiment, the pin uncoupled to a touch-sensing switch may be coupled to a conductive element such as a conductive trace, and the conductive element is shielded from user interaction so that it is unresponsive to the presence of a conductive object. Next, a difference value between the signal read from the pin uncoupled to a touch-sensing switch and the pin's baseline value is calculated (step 620). If the difference value between the signal read from the pin uncoupled to a touch-sensing switch and the pin's baseline value exceeds a predetermined range for a predetermined amount of time, the baseline values of all pins are adjusted (step 630).

In one embodiment, step 630 may include steps 631-638 that determine whether the difference value from step 620 is outside of a specified range and update the baseline values if necessary. In step 631, it is determined whether the difference value is outside of a specified range. If the difference value is not outside of the specified range, an abnormal count variable is reset to zero (step 637). If the difference value is outside of a specified range, the abnormal count variable is incremented (step 632). Next, it is determined whether the abnormal count variable is above a specified threshold (step 633). If the abnormal count variable is not above a specified threshold, baseline values of all the pins are updated in step 638 (e.g., by calling a baseline update function); and in this case there may not be any changes made to the baseline values. If the abnormal count variable is above a specified threshold, the difference value from step 620 is multiplied by a predetermined factor and the result is stored in a temporary variable (step 634). In an alternative embodiment, in step 634, a predetermined factor may be added to the difference value. The value in the temporary variable is then added to the baseline values of all the pins (step 635). The abnormal count variable is reset to zero (step 636), and the baseline values of all the pins are updated (step 638). In step 638, how the baseline values are updated depends on the environmental effect. For example, if the ambient temperature is increasing, the baseline values are increased accordingly; and, likewise, if the ambient temperature is decreasing, the baseline values are decreased accordingly. Additional details regarding alternative embodiments of compensating for environmental effects have not been included so as to not obscure the present embodiments, and because these alternative embodiments are known by those of ordinary skill in the art.

FIG. 7 illustrates a block diagram of one embodiment of an electronic system having a processing device for detecting a presence of a conductive object and compensating for the effect of an environmental factor. In one embodiment, electronic system 700 may include the method and apparatus described hereinbefore and illustrated in FIGS. 2 through 6B. Electronic system 700 includes processing device 230, touch-sensor pad 720, touch-sensor slider 730, touch-sensor buttons 740, host processor 750, embedded controller 760 and non-capacitive sensor elements 770. The processing device 230 may include analog and/or digital general purpose input/output (“GPIO”) ports 707. GPIO ports 707 may be programmable. GPIO ports 707 may be coupled to a Programmable Interconnect and Logic (“PIL”), which acts as an interconnect between GPIO ports 707 and a digital block array of the processing device 230 (not illustrated). The digital block array may be configured to implement a variety of digital logic circuits (e.g., DAC, digital filters, digital control systems, etc.) using, in one embodiment, configurable user modules (“UMs”). The digital block array may be coupled to a system bus. Processing device 230 may also include memory, such as random access memory (RAM) 705 and program flash 704. RAM 705 may be static RAM (SRAM), and program flash 704 may be a non-volatile storage, which may be used to store firmware (e.g., control algorithms executable by processing core 702 to implement operations described herein). Processing device 230 may also include a memory controller unit (MCU) 703 coupled to memory and the processing core 702.

The processing device 230 may also include an analog block array (not illustrated). The analog block array is also coupled to the system bus. Analog block array also may be configured to implement a variety of analog circuits (e.g., ADC, analog filters, etc.) using, in one embodiment, configurable UMs. The analog block array may also be coupled to the GPIO 707.

As illustrated, capacitive sensor 410 may be integrated into processing device 230. Capacitive sensor 410 may include analog I/O for coupling to an external component, such as touch-sensor pad 720, touch-sensor slider 730, touch-sensor buttons 740, and/or other devices.

It should be noted that the embodiments described herein are not limited to touch-sensor pads for notebook implementations, but can be used in other capacitive sensing implementations, for example, the sensing device may be a touch-sensor slider 730, or a touch-sensor button 740 (e.g., capacitance sensing button). Similarly, the operations described herein are not limited to notebook cursor operations, but can include other operations, such as lighting control (dimmer), volume control, graphic equalizer control, speed control or other control operations requiring gradual adjustments. It should also be noted that these embodiments of capacitive sensing implementations may be used in conjunction with non-capacitive sensing elements, including but not limited to pick buttons, sliders (e.g., display brightness and contrast), scroll-wheels, multi-media control (e.g., volume, track advance, etc) handwriting recognition and numeric keypad operation.

In one embodiment, the electronic system 700 includes a touch-sensor pad 720 coupled to the processing device 230 via bus 721. Touch-sensor pad 720 may include a multi-dimension sensor array. The multi-dimension sensor array comprises a plurality of sensor elements, organized as rows and columns. In an alternative embodiment, the electronic system 700 includes a touch-sensor slider 730 coupled to the processing device 230 via bus 731. Touch-sensor slider 730 may include a single-dimension sensor array. The single-dimension sensor array comprises a plurality of sensor elements, organized as rows, or alternatively, as columns. In another embodiment, the electronic system 700 includes a touch-sensor button 740 coupled to the processing device 230 via bus 741. Touch-sensor button 740 may include a single-dimension or multi-dimension sensor array. The single- or multi-dimension sensor array comprises a plurality of sensor elements. For a touch-sensor button, the plurality of sensor elements may be coupled together to detect a presence of a conductive object over the entire surface of the sensing device. Alternatively, the touch-sensor button 740 has a single sensor element to detect the presence of the conductive object. In one embodiment, the touch-sensor button 740 may be a capacitive sensor element. Capacitive sensor elements may be used as non-contact switches. These switches, when protected by an insulating layer, offer resistance to severe environments.

The electronic system 700 may include any combination of one or more of the touch-sensor pad 720, touch-sensor slider 730 and/or touch-sensor button 740. In an alternative embodiment, the electronic system 700 may also include non-capacitive sensor elements 770 coupled to the processing device 230 via bus 771. The non-capacitive sensor elements 770 may include buttons, light emitting diodes (LEDs) and other user interface devices, such as a mouse, a keyboard or other functional keys that do not require capacitance sensing. In one embodiment, buses 771, 741, 731 and 721 may be a single bus. Alternatively, these buses may be configured into any combination of one or more separate buses.

The processing device may also provide value-added functionality such as keyboard control integration, LEDs, battery charger and general purpose I/O, as illustrated as non-capacitive sensor elements 770. Non-capacitive sensor elements 770 are coupled to the GPIO 707.

Processing device 230 may include internal oscillator/clocks 706 and communication block 708. The oscillator/clocks block 706 provides clock signals to one or more of the components of processing device 230. Communication block 708 may be used to communicate with an external component, such as a host processor 750, via host interface (I/F) line 751. Alternatively, processing device 230 may also be coupled to embedded controller 760 to communicate with the external components, such as host 750. Interfacing to the host 750 can be through various methods. In one exemplary embodiment, interfacing with the host 750 may be done using a standard PS/2 interface to connect to an embedded controller 760, which in turn sends data to the host 750 via low pin count (LPC) interface. In some instances, it may be beneficial for the processing device 230 to do both touch-sensor pad and keyboard control operations, thereby freeing up the embedded controller 760 for other housekeeping functions. In another exemplary embodiment, interfacing may be done using a universal serial bus (USB) interface directly coupled to the host 750 via host interface line 751. Alternatively, the processing device 230 may communicate to external components, such as the host 750 using industry standard interfaces, such as USB, PS/2, inter-integrated circuit (I2C) bus, or system packet interfaces (SPI). The host 750 and/or embedded controller 760 may be coupled to the processing device 230 with a ribbon or flex cable from an assembly, which houses the sensing device and processing device.

In one embodiment, the processing device 230 is configured to communicate with the embedded controller 760 or the host 750 to send and/or receive data. The data may be a command or alternatively a signal. In an exemplary embodiment, the electronic system 700 may operate in both standard-mouse compatible and enhanced modes. The standard-mouse compatible mode utilizes the HID class drivers already built into the Operating System (OS) software of host 750. These drivers enable the processing device 230 and sensing device to operate as a standard cursor control user interface device, such as a two-button PS/2 mouse. The enhanced mode may enable additional features such as scrolling (reporting absolute position) or disabling the sensing device, such as when a mouse is plugged into the notebook. Alternatively, the processing device 230 may be configured to communicate with the embedded controller 760 or the host 750, using non-OS drivers, such as dedicated touch-sensor pad drivers, or other drivers known by those of ordinary skill in the art.

In other words, the processing device 230 may operate to communicate data (e.g., commands or signals) using hardware, software, and/or firmware, and the data may be communicated directly to the processing device of the host 750, such as a host processor, or alternatively, may be communicated to the host 750 via drivers of the host 750, such as OS drivers, or other non-OS drivers. It should also be noted that the host 750 may directly communicate with the processing device 230 via host interface 751.

In one embodiment, the data sent to the host 750 from the processing device 230 includes click, double-click, movement of the cursor, scroll-up, scroll-down, scroll-left, scroll-right, step back, step forward, Rewind, Fast Forward, Play, Stop, etc. Alternatively, other user interface device commands may be communicated to the host 750 from the processing device 230. These commands may be based on gestures occurring on the sensing device that are recognized by the processing device, such as tap, push, hop, and zigzag gestures. Alternatively, other commands may be recognized. Similarly, signals may be sent that indicate the recognition of these operations.

In particular, a tap gesture, for example, may be a user's finger (e.g., conductive object) is on the sensing device for less than a threshold time. If the time the finger is placed on the touchpad is greater than the threshold time it may be considered to be a movement of the cursor, in the x- or y-axes. Scroll-up, scroll-down, scroll-left, and scroll-right, step back, and step-forward may be detected when the absolute position of the conductive object is within a pre-defined area, and movement of the conductive object is detected.

Processing device 230 may reside on a common carrier substrate such as, for example, an integrated circuit (IC) die substrate, a multi-chip module substrate or the like. Alternatively, the components of processing device 230 may be one or more separate integrated circuits and/or discrete components. In one exemplary embodiment, processing device 230 may be a Programmable System on a Chip (PSoC™) processing device, manufactured by Cypress Semiconductor Corporation, San Jose, Calif. Alternatively, processing device 230 may be one or more other processing devices known by those of ordinary skill in the art, such as a microprocessor or central processing unit, a controller, special-purpose processor, digital signal processor (DSP), an application specific integrated circuit (ASIC), a field programmable gate array (FPGA), or the like. In an alternative embodiment, for example, the processing device may be a network processor having multiple processors including a core unit and multiple microengines. Additionally, the processing device may include any combination of general-purpose processing device(s) and special-purpose processing device(s).

It should be noted that the embodiments described herein are not limited to having a configuration of a processing device coupled to a host, but may include a system that measures the capacitance on the touch-sensing device and sends the new data to a host computer where it is analyzed by an application. In effect the processing that is done by processing device 230 may also be done in the host.

In one embodiment, the method and apparatus described herein may be implemented in a fully self-contained touch-sensor pad, which outputs fully processed x/y movement and gestures data signals or data commands to a host. In an alternative embodiment, the method and apparatus may be implemented in a touch-sensor pad, which outputs x/y movement data and also finger presence data to a host, and where the host processes-the received data to detect gestures. In another embodiment, the method and apparatus may be implemented in a touch-sensor pad, which outputs raw capacitance data to a host, where the host processes the capacitance data to compensate for quiescent and stray capacitance, and calculate x/y movement and detects gestures by processing the capacitance data. Alternatively, the method and apparatus may be implemented in a touch-sensor pad, which outputs pre-processed capacitance data to a host, where the touch-sensor pad processes the capacitance data to compensate for quiescent and stray capacitance, and the host calculate x/y movement and detects gestures from the pre-processed capacitance data.

In one embodiment, the electronic system that includes the embodiments described herein may be implemented in a conventional laptop touch-sensor pad. Alternatively, it may be implemented in a wired or wireless keyboard integrating a touch-sensor pad, which is itself connected to a host. In such an implementation, the processing described above as being performed by the “host” may be performed in part or in whole by the keyboard controller, which may then pass fully processed, pre-processed or unprocessed data to the system host. In another embodiment, the embodiments may be implemented in a mobile handset (e.g., cell phone) or other electronic devices where the touch-sensor pad may operate in one of two or more modes. For example, the touch-sensor pad may operate either as a touch-sensor pad for x/y positioning and gesture recognition, or as a keypad or other array of touch-sensor buttons and/or sliders.

Capacitive sensor 410 may be integrated into the IC of the processing device 230, or alternatively, in a separate IC. Alternatively, descriptions of capacitive sensor 410 may be generated and compiled for incorporation into other integrated circuits. For example, behavioral level code describing capacitive sensor 410, or portions thereof, may be generated using a hardware descriptive language, such as VHDL or Verilog, and stored to a machine-accessible medium (e.g., CD-ROM, hard disk, floppy disk, etc.). Furthermore, the behavioral level code can be compiled into register transfer level (“RTL”) code, a netlist or even a circuit layout and stored to a machine-accessible medium. The behavioral level code, the RTL code, the netlist and the circuit layout all represent various levels of abstraction to describe capacitive sensor 410.

It should be noted that the components of electronic system 700 may include all the components described above. Alternatively, electronic system 700 may include only some of the components described above.

In one embodiment, electronic system 700 may be used in a notebook computer. Alternatively, the electronic device may be used in other applications, such as a mobile handset, a personal data assistant (PDA), a keyboard, a television, a remote control, a monitor, a handheld multi-media device, a handheld video player, a handheld gaming device, or a control panel.

In one embodiment, capacitive sensor 410 may be a capacitive sensor relaxation oscillator (CSR). The CSR may have an array of capacitive touch switches using a current-programmable relaxation oscillator, an analog multiplexer, digital counting functions and high-level software routines to compensate for environmental and physical switch variations. The switch array may include combinations of independent switches, sliding switches (e.g., touch-sensor slider), and touch-sensor pads implemented as a pair of orthogonal sliding switches. The CSR may include physical, electrical, and software components. The physical component may include the physical switch itself, typically a pattern constructed on a printed circuit board (PCB) with an insulating cover, a flexible membrane or a transparent overlay. The electrical component may include an oscillator or other means to convert a changed capacitance into a measured signal. The electrical component may also include a counter or timer to measure the oscillator output. The software component may include detection and compensation software algorithms to convert the count value into a switch detection decision. For example, in the case of slide switches or X-Y touch-sensor pads, a calculation for finding position of the conductive object to greater resolution than the physical pitch of the switches may be used.

It should be noted that there are various known methods for measuring capacitance. Although the embodiments described herein are described using a relaxation oscillator, the present embodiments are not limited to using relaxation oscillators, but may include other methods, such as current versus voltage phase shift measurement, resistor-capacitor charge timing, capacitive bridge divider, charge transfer, or the like.

The current versus voltage phase shift measurement may include driving the capacitance through a fixed-value resistor to yield voltage and current waveforms that are out of phase by a predictable amount. The drive frequency can be adjusted to keep the phase measurement in a readily measured range. The resistor-capacitor charge timing may include charging the capacitor through a fixed resistor and measuring timing on the voltage ramp. Small capacitor values may require very large resistors for reasonable timing. The capacitive bridge divider may include driving the capacitor under test through a fixed reference capacitor. The reference capacitor and the capacitor under test form a voltage divider. The voltage signal is recovered with a synchronous demodulator, which may be done in the processing device 230. The charge transfer may be conceptually similar to an R-C charging circuit. In this method, C_{P} is the capacitance being sensed. C_{SUM} is the summing capacitor, into which charge is transferred on successive cycles. At the start of the measurement cycle, the voltage on C_{SUM} is reset. The voltage on C_{SUM} increases exponentially (and only slightly) with each clock cycle. The time for this voltage to reach a specific threshold is measured with a counter. Additional details regarding these alternative embodiments have not been included so as to not obscure the present embodiments, and because these alternative embodiments for measuring capacitance are known by those of ordinary skill in the art.

Embodiments of the present invention, described herein, include various operations. These operations may be performed by hardware components, software, firmware or a combination thereof. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; electrical, optical, acoustical, or other form of propagated signal (e.g., carrier waves, infrared signals, digital signals, etc.); or another type of medium suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method, comprising:
detecting an environmental effect on a touch-sensing device using a touch sensor that is unresponsive to a presence of a conductive object during the detecting;
detecting the presence of the conductive object; and
compensating for the environmental effect on the detection of the conductive object.

2. The method of claim 1, wherein the touch-sensing device further comprises a touch-sensing switch coupled to the touch sensor, and wherein the touch-sensing switch is responsive to the presence of the conductive object and the environmental effect.

3. The method of claim 2, wherein the touch sensor comprises a plurality of pins, wherein a first pin of the plurality of pins is uncoupled to the touch-sensing switch, and wherein a second pin of the plurality of pins is coupled to the touch-sensing switch.

4. The method of claim 3, wherein compensating for the environmental effect on the detection of the conductive object comprises:
reading a signal corresponding to the environmental effect from the first pin;
calculating a difference value between the signal and a first baseline value related to the first pin; and
adjusting the first baseline value related to the first pin and a second baseline value related to the second pin if the difference value exceeds a predetermined range for a predetermined amount of time.

5. The method of claim 4, wherein adjusting the first baseline value related to the first pin and the second baseline value related to the second pin if the difference value exceeds the predetermined range for the predetermined amount of time comprises:
determining whether the difference value exceeds the predetermined range for the predetermined amount of time by using an abnormal count variable;
increasing the baseline values by a multiple of the difference value if the difference value exceeds the predetermined range for the predetermined amount of time; and
resetting the abnormal count variable.

6. The method of claim 3, wherein the touch sensor further comprises a capacitive sensor and wherein the touch-sensing switch comprises a capacitive switch.

7. The method of claim 6, wherein the capacitive sensor comprises:
a relaxation oscillator having the plurality of pins; and
a digital counter coupled to the relaxation oscillator.

8. The method of claim 3, wherein the first pin is coupled to a conductive element and wherein the conductive element is unresponsive to the presence of the conductive object.

9. An apparatus, comprising:
a touch-sensing device comprising:
a touch sensor to detect an environmental effect and a presence of a conductive object on the touch-sensing device, wherein the touch sensor is unresponsive to the presence of the conductive object during the detection of the environmental effect; and
a processing device coupled to the touch sensor to compensate for the environmental effect on the detection of the conductive object.

10. The apparatus of claim 9, wherein the touch-sensing device further comprises a touch-sensing switch coupled to the touch sensor, and wherein the touch-sensing switch is responsive to the presence of the conductive object and the environmental effect.

11. The apparatus of claim 10, wherein the touch sensor comprises a plurality of pins, wherein a first pin of the plurality of pins is uncoupled to the touch-sensing switch, and wherein a second pin of the plurality of pins is coupled to the touch-sensing switch.

12. The apparatus of claim 11, wherein the processing device is configured to read a signal corresponding to the environmental effect from the first pin.

13. The apparatus of claim 11, wherein the processing device is configured to calculate a difference value between a signal corresponding to the environmental effect from the first pin and a first baseline value related to the first pin.

14. The apparatus of claim 11, wherein the processing device is configured to adjust a first baseline value related to the first pin and a second baseline value related to the second pin if a difference value between a signal corresponding to the environmental effect from the first pin and the first baseline value exceeds a predetermined range for a predetermined amount of time.

15. The apparatus of claim 11, wherein the touch sensor is a capacitive sensor and the touch-sensing switch is a capacitive switch.

16. The apparatus of claim 15, wherein the capacitive sensor comprises:
a relaxation oscillator having the plurality of pins; and
a digital counter coupled to the relaxation oscillator.

17. The apparatus of claim 1 1, wherein the first pin is coupled to a conductive element and wherein the conductive element is unresponsive to the presence of the conductive object.

18. An apparatus, comprising:
means for detecting an environmental effect on a touch-sensing device without using a dedicated environmental effect sensor;
means for detecting a presence of a conductive object; and
means for compensating for the environmental effect on the detection of the conductive object.
